(19) United States
(12) Patent Application Publication
(10) Pub. No.: US 2016/0057583 A1
(43) Pub. Date: Feb. 25, 2016

(54) POSITION ESTIMATION DEVICE

(71) Applicant: KABUSHIKI KAISHA TOSHIBA, Tokyo (JP)

(72) Inventors: Cam Iy NGUYEN, Yokohama (JP); Yusuke DOI, Yokohama (JP)

(21) Appl. No.: 14/806,932

(22) Filed: Jul. 23, 2015

(30) Foreign Application Priority Data
Aug. 20, 2014 (JP) 2014-167920

(51) Int. Cl. H04W 4/02; H04L 12/24; H04L 12/733

(52) U.S. Cl. CPC H04W 4/028; H04L 45/122; H04L 41/12

(57) ABSTRACT

According to an embodiment, a position estimation device is for estimating a position of a second terminal in a wireless network. The wireless network included a plurality of terminals including three or more first terminals whose positions are known and the second terminal whose position is unknown. The device includes a first probability calculator and a position estimator. The first probability calculator calculates a first connection probability on the basis of a distance and a smallest hop count between two of the plurality of terminals over which and with which the two terminals are connected. The position estimator obtains a likelihood on the basis of the first connection probability and estimates a position of the second terminal by using the likelihood.

### CROSS-REFERENCE TO RELATED APPLICATION(S)

This application is based upon and claims the benefit of priority from Japanese Patent Application No. 2014-167920, filed on Aug. 20, 2014; the entire contents of which are incorporated herein by reference.

### FIELD

Embodiments described herein relate generally to a position estimation device.

### BACKGROUND

There are known wireless networks in which a plurality of wireless terminals spread spatially communicate with one another and in which each wireless terminal is capable of communicating via other wireless terminals. Such a wireless network is called a wireless mesh network, and a wireless terminal in a wireless mesh network is called a node. In such a wireless mesh network, position estimation of each node is an important technology.

A node that is a target of position estimation needs to be capable of communicating with at least three nodes (referred to as anchor nodes) whose positions are known. There is known a technology allowing estimation of the position of a target by using multihop communication even when the target cannot communicate directly with an anchor node.

Note that multihop communication refers to a form of communication that is relayed once or more times by a third wireless device. The number of times communication is relayed by wireless devices is called a hop count. Furthermore, a hop count between two nodes refers to the smallest hop count (the shortest path).

In wireless mesh networks, there is a diversity of disposition of nodes, such as disposition in which the hop count between nodes is large and the distance therebetween is small or disposition in which the hop count between nodes is small and the distance therebetween is large. In related art, the probability that the hop count between nodes is large and the distance therebetween in small and the probability that the hop count is small and the distance is large as mentioned above have not been considered. There has thus been a problem in estimation of positions of targets that errors in estimated positions may be large.

### BRIEF DESCRIPTION OF THE DRAWINGS

FIG. 1 is a flowchart schematically illustrating a position estimation method according to an existing technology;

FIG. 2 is a diagram schematically illustrating an example of a wireless mesh network that can be applied to a first embodiment;

FIGS. 3A and 3B are block diagrams illustrating examples of a configuration of an anchor terminal that can be applied to the first embodiment;

FIG. 4 is a block diagram illustrating an example configuration of a target terminal that can be applied to the first embodiment;

FIG. 5 is a table illustrating information transmitted and received among a position estimation device, anchor terminals, and target terminals according to the first embodiment;

FIG. 6 is a block diagram illustrating an example configuration of the position estimation device according to the first embodiment;

FIG. 7 is a block diagram illustrating a hardware configuration of the position estimation device according to the first embodiment;

FIG. 8 is a flowchart schematically illustrating a position estimation method according to the first embodiment;

FIG. 9 is an example flowchart illustrating a k hop connection probability calculation process according to the first embodiment;

FIG. 10 is a diagram for explaining calculation of a k-hop connection probability according to the first embodiment;

FIG. 11 is a diagram for explaining calculation of a k-hop connection probability according to the first embodiment;

FIG. 12 is a graph illustrating an example in which the k-hop connection probability is plotted;

FIG. 13 is a graph illustrating an example in which an appropriate fitting function is applied to the plot of k-hop connection probability;

FIG. 14 is a diagram schematically illustrating an example of a wireless mesh network that can be applied to a second embodiment;

FIG. 15 is a block diagram illustrating an example configuration of a target terminal according to the second embodiment; and

FIG. 16 is a table illustrating information transmitted and received among anchor terminals and target terminals according to the second embodiment.

### DETAILED DESCRIPTION

According to an embodiment, a position estimation device is for estimating a position of a second terminal in a wireless network. The wireless network included a plurality of terminals including three or more first terminals whose positions are known and the second terminal whose position is unknown. The device includes a first probability calculator and a position estimator. The first probability calculator calculates a first connection probability on the basis of a distance and a hop count between two of the plurality of terminals over which and with which the two terminals are connected. The position estimator estimates a position of the second terminal on the basis of the first connection probability.

A position estimation device according to an embodiment will be described below. Prior to the description of the position estimation device according to an embodiment, a position estimation method in a wireless mesh network according to an existing technology will be described for easy understanding. Note that the wireless mesh network includes a plurality of terminals, which include target terminals whose positions are unknown, and three or more anchor terminals whose positions are known. The terminals included in the wireless mesh network are called nodes.

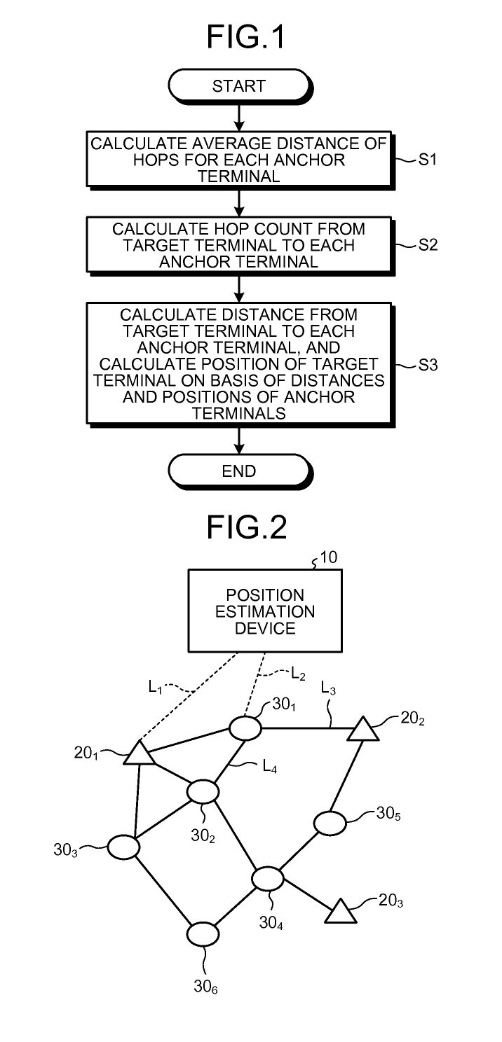

FIG. 1 is a flowchart schematically illustrating the position estimation method according to the DV-Hop scheme that is an existing technology. In FIG. 1, in step S1, the position estimation device calculates an average distance of hops for each anchor terminal. In the next step S2, the position estimation device calculates the hop counts from each target terminal to anchor terminals. In step S3, the position estimation device calculates the distances from each target terminal to the anchor terminals, and calculates the positions of the target terminals on the basis of the distances obtained by the calculation and the positions of the anchor terminals.

According to this method, the position of a target terminal can be estimated even when the target terminal cannot directly communicate with anchor terminals. With this method, however, since cases in which the hop count between nodes is large and the distance therebetween is small and cases in which the hop count between nodes is small and the distance therebetween is large are not considered, errors in the estimated positions are large. Embodiments described below allow estimation of positions of target terminals with higher accuracy.

### First Embodiment

Next, a first embodiment will be described. FIG. 2 is a schematically illustrates an example of a wireless mesh network that can be applied to the first embodiment. In FIG. 2, the wireless mesh network includes a position estimation device 10, three or more anchor terminals 20₁, 20₂, . . . , and a plurality of target terminals 30₁, 30₂, . . . .

The anchor terminals 20₁, 20₂, . . . are reference wireless devices whose positions are known. The anchor terminals 20₁, 20₂, . . . may acquire their positions by using position detector such as a global positioning system (GPS) or may have stored their positions in a storage unit 105 (which will be described later) of the position estimation device 10. The position estimation device 10 stores position information indicating the positions of the anchor terminals 20₁, 20₂, . . . . The position estimation device 10 may acquire the position information by receiving the position information from the anchor terminals 20₁, 20₂, . . . , or may have the position information stored in advance.

The positions of the target terminals 30₁, 30₂, . . . are not known to the position estimation device 10 and the anchor terminals 20₁, 20₂, . . . . In the first embodiment, the position estimation device 10 estimates the positions of the target terminals 30₁, 30₂, . . . on the basis of information acquired from the anchor terminals 20₁, 20₂, . . . and the target terminals 30₁, 30₂, . . . .

In FIG. 2, a communication pathway (communication path) between an anchor terminal (the anchor terminal 20₁, for example) and the position estimation device 10 is represented by a path L₁, and a communication path between a target terminal (the target terminal 30₁, for example) and the position estimation device 10 is represented by a path L₂. Furthermore, a communication path between an anchor terminal (the anchor terminal 20₂, for example) and a target terminal (the target terminal 30₁, for example) is represented by a path L₃, and a communication path between target terminals (the target terminals 30₁ and 30₂, for example) is represented by a path L₄.

Hereinafter, the anchor terminals 20₁, 20₂, . . . will be represented by an anchor terminal 20 unless the anchor terminal 20₁, 20₂, . . . are particularly distinguished from one another. Similarly, the target terminals 30₁, 30₂, . . . will be represented by a target terminal 30 unless the target terminals 30₁, 30₂, . . . are particularly distinguished from one another.

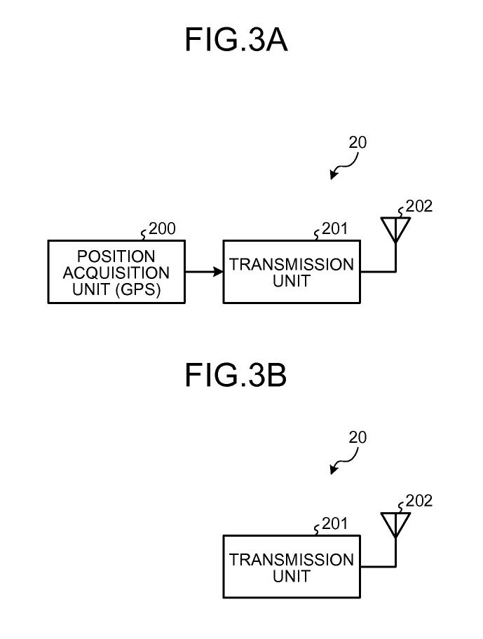

FIGS. 3A and 3B illustrates examples of the configuration of the anchor terminal 20 that can be applied to the first embodiment. In FIG. 3A, the anchor terminal 20 includes a position acquisition unit 200, a transmission unit 201, and an antenna 202. The position acquisition unit 200 acquires the position of the anchor terminal 20. The position acquisition unit 200 includes a GPS signal reception unit that receives a signal from a GPS, and a position calculator that calculates the position on the basis of the signal received by the GPS signal reception unit, and outputs information indicating the calculated position, for example.

The transmission unit 201 transmits the position information output from the position acquisition unit 200 with identification information (anchor ID) for identifying the anchor terminal itself added thereto to the position estimation device 10 via the antenna 202. In this process, when the anchor terminal 20 is not directly connected to the position estimation device 10, the transmission unit 201 transmits the position information and the anchor ID to the position estimation device 10 via another terminal (an anchor terminal 20 or a target terminal 30).

FIG. 3B illustrates another example of the configuration of the anchor terminal 20. In FIG. 3B, the anchor terminal 20 does not include the position acquisition unit 200 in FIG. 3A, and have the position information of the anchor terminals 20 stored in the position estimation device 10 in advance. The configuration illustrated in FIG. 3B is a configuration used for a position estimation system in which the positions of the anchor terminals 20 are predetermined.

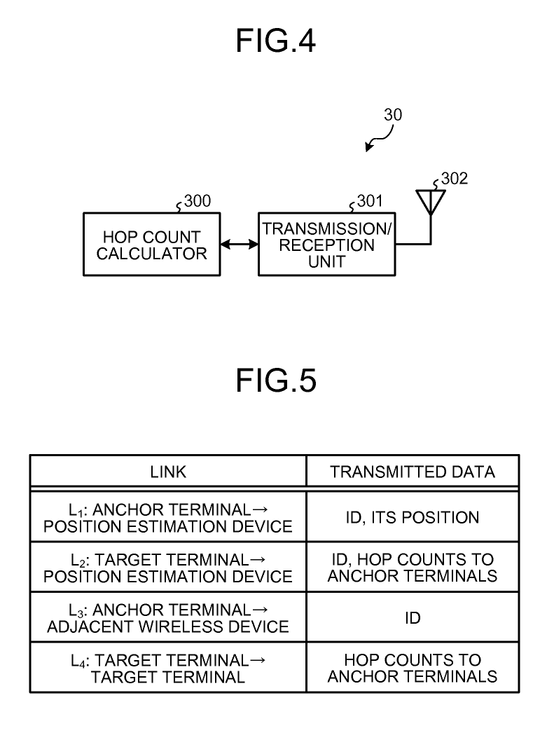

FIG. 4 illustrates an example configuration of a target terminal 30 that can be applied to the first embodiment. In FIG. 4, the target terminal 30 includes a hop count calculator 300, a transmission/reception unit 301 and an antenna 302. The transmission/reception unit 301 transmits and receives signals via the antenna 302. The transmission/reception unit 301 receives, from another target terminal 30 that is adjacent thereto, hop counts of this adjacent target terminal 30 with respect to the anchor terminals 20₁, 20₂, . . . . The transmission/reception unit 301 also receives an anchor ID from an adjacent anchor terminal 20.

The transmission/reception unit 301 transmits the hop counts of the target terminal 30 with respect to the anchor terminals 20₁, 20₂, . . . calculated by the hop count calculator 300 with a target ID for identifying the target terminal 30 added thereto to the position estimation device 10 via the antenna 302. In this process, when the target terminal 30 is not directly connected to the position estimation device 10, the transmission/reception unit 301 transmits the hop counts to the anchor terminals 20 and the target ID to the position estimation device 10 via another terminal (an anchor terminal 20 or a target terminal 30).

The hop count calculator 300 calculates the hop counts of the target terminal 30 with respect to the anchor terminals 20₁, 20₂, . . . on the basis of the hop counts of another target terminal 30 received by the transmission/reception unit 301.

An example of the method for calculating the hop counts by the hop count calculator 300 will be described. As an example, a case of calculating a hot count of a target terminal 30 (referred to as a target terminal 30ₛ) having a target ID=s to an anchor terminal 20 (referred to as an anchor terminal 20ₜ) having an anchor ID=t will be considered. The hop count calculator 300 first initializes the hop count to the anchor terminal 20ₜ to an infinite value. When the target terminal 30ₛ has received the anchor ID transmitted from the anchor terminal 20ₜ directly, that is, without relay of other target terminals 30, the hop count calculator 300 sets the hop count to “1.”

When the target terminal 30, has received a hop count (of a value u) between an adjacent target terminal 30 and the anchor terminal 20ₜ from the adjacent target terminal 30, the hop count calculator 300 carries out a determination process according to the value of the hop count. Specifically, when the received hot count is larger than the value (u+1), the hop count calculator 300 updates the hop count between the target terminal 30ₛ and the anchor terminal 20ₜ with the value (u+1). The hop count calculator 300 transmits the updated hop count to the adjacent target terminal 30. The hop count calculator 300 repeats the procedures described above until the hop count is not updated any more.

FIG. 5 is a table illustrating information transmitted and received among the position estimation device 10, the anchor terminals 20, and the target terminals 30 according to the first embodiment. Note that the paths through which the position estimation device 10, the anchor terminals 20, and the target terminals 30 can communicate with one another are referred to as links, and a state of a path in which communication therethrough is possible is referred to as being linked.

With reference to FIG. 2, through the path L₁, that is a link from an anchor terminal 20 to the position estimation device 10, the anchor ID of the anchor terminal 20 and the position information indicating the position of the anchor terminal 20 are transmitted from the anchor terminal 20 to the position estimation device 10. Through the path L₂, that is a link from a target terminal 30 to the position estimation device 10, the target ID of the target terminal 30 and hop counts of the target terminal 30 with respect to the anchor terminals 20 are transmitted.

Through the path L₃, that is a link from an anchor terminal 20 to an adjacent wireless device, the anchor ID of the anchor terminal 20 is transmitted. Note that the adjacent wireless device refers to another terminal with which a subject wireless device (an anchor terminal 20, a target terminal 30) can directly communicate. Through the path L₄, that is a link from a target terminal 30 to another target terminal 30, the hop counts of the target terminal 30 with respect to the anchor terminals 20 are transmitted.

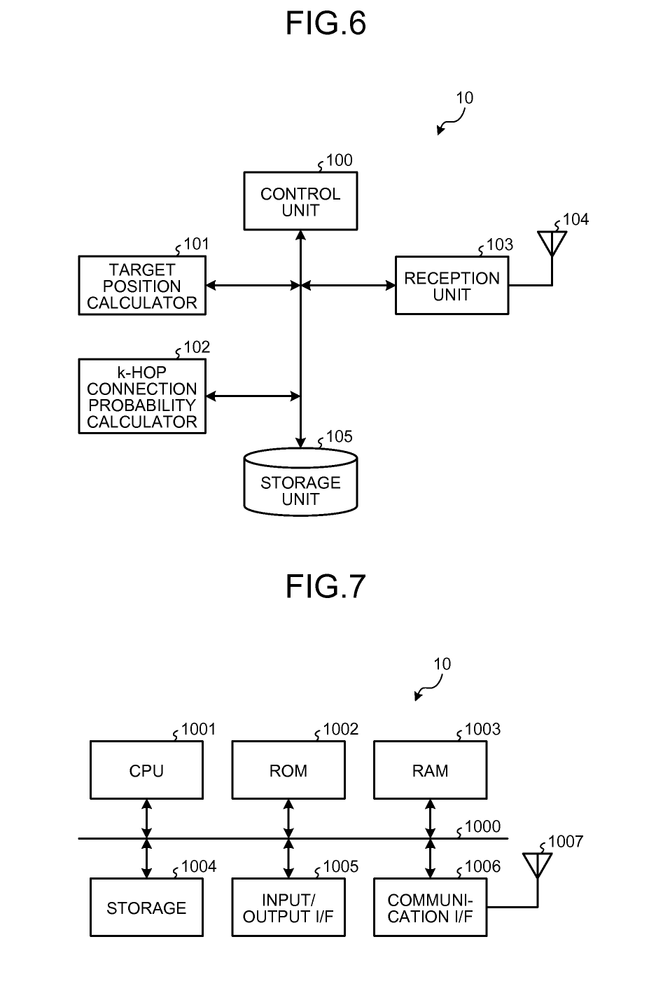

FIG. 6 is a block diagram illustrating an example configuration of the position estimation device 10 according to the first embodiment. In FIG. 6, the position estimation device 10 includes a control unit 100, a target position calculator 101, a k-hop connection probability calculator 102, a reception unit 103, an antenna 104, and a storage unit 105. In the position estimation device 10, the storage unit 105 is a storage device such as a hard disk drive or a nonvolatile semiconductor memory. The control unit 100, the target position calculator 101, the k-hop connection probability calculator 102, and the reception unit 103 may be implemented by programs running on a central processing unit (CPU) or may be implemented by hardware components that operate in cooperation with one another.

In the position estimation device 10, the reception unit 103 receives information transmitted from the anchor terminals 20 and the target terminals 30 via the antenna 104. The reception unit 103 writes the received information into the storage unit 105. The k-hop connection probability calculator 102 calculates a k-hop connection probability, which will be described later, written in the storage unit 105. The target position calculator 101 calculates the positions of the target terminals 30 by using the k-hop connection probability calculated by the k-hop connection probability calculator 102 and the hop counts of the target terminals 30 and the anchor terminals 20 received by the reception unit 103. The control unit 100 controls the overall operation of the position estimation device 10.

FIG. 7 illustrates an example of the hardware configuration of the position estimation device 10 according to the first embodiment. In FIG. 7, the position estimation device 10 can be achieved by a configuration equivalent to that of a typical computer system, and includes a CPU 1001, a read only memory (ROM) 1002, a random access memory (RAM) 1003, a storage 1004, an input/output interface (I/F) 1005, a communication interface (I/F) 1006, and an antenna 1007. The CPU 1001, the ROM 1002, the RAM 1003, the storage 1004, the input/output I/F 1005, and the communication I/F 1006 are connected with one another via a bus 1000.

The storage 1004 can be a hard disk drive or a nonvolatile semiconductor memory. The CPU 1001 controls the overall operation of the position estimation device 10 by using the RAM 1003 as a work memory according to programs stored in advance in the ROM 1002 or the storage 1004. The input/output I/F 1005 is an interface for inputting data from outside and outputting data to outside. The input/output I/F 1005 can be connected with an input device such as a keyboard and an output device such as a display device. The input/output I/F 1005 can also transmit/receive data to/from external devices. The communication I/F 1006 converts a signal received from the antenna 1007 into digital data, and passes the data to the CPU 1001.

The functions of the control unit 100, the target position calculator 101, the k-hop connection probability calculator 102, and the reception unit 103 in the position estimation device 10 described above can be implemented by position estimation programs running on the CPU 1001. The position estimation programs are recorded on a computer readable recording medium such as a CD, a flexible disk, or a DVD in a form of a file that can be installed or executed, and provided therefrom, for example. Alternatively, the position estimation programs may be stored in the ROM 1002 in advance and provided to the position estimation device 10.

Still alternatively, the position estimation programs may be stored on a computer connected to a network such as the Internet or a local area network (LAN), and provided to the position estimation device 10 by being downloaded via the network. Still alternatively, the position estimation programs may be provided or distributed through a network such as the Internet.

The position estimation programs according to the embodiments have modular structure including the control unit 100, the target position calculator 101, the k-hop connection probability calculator 102, and the reception unit 103 described above, for example. In an actual hardware configuration, the CPU 1001 reads out the position estimation programs from the storage 1004, for example, and executes the programs, whereby the respective units are loaded on the RAM 1003 and the control unit 100, the target position calculator 101, the k-hop connection probability calculator 102, and the reception unit 103 are generated on the RAM 1003.

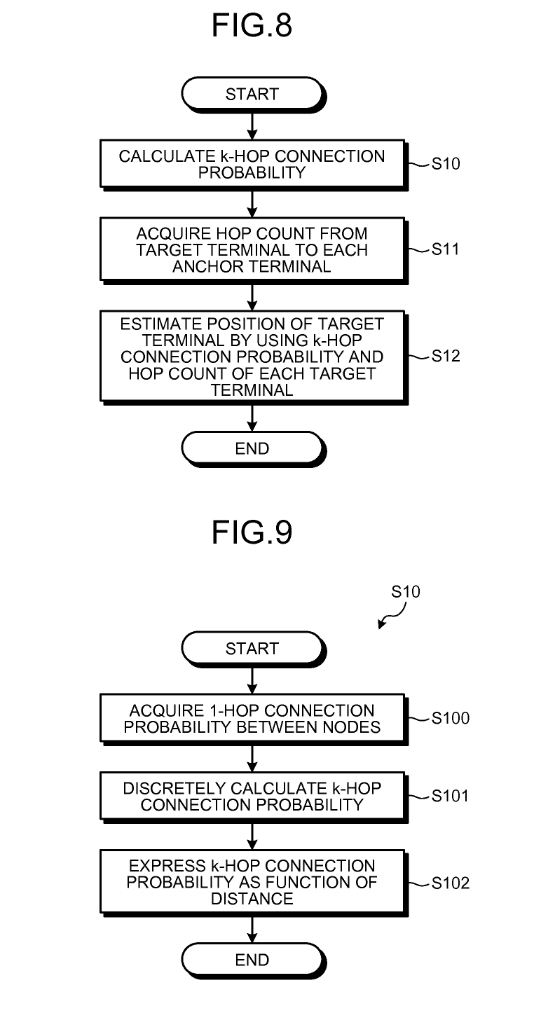

Next, a position estimation method according to the first embodiment will be described. FIG. 8 is a flowchart schematically illustrating the position estimation method according to the first embodiment. In step S10, the position estimation device 10 calculates a k-hop connection probability by the k-hop connection probability calculator 102. In the next step S11, the position estimation device 10 acquires the hop counts of each target terminal 30 with respect to the anchor terminals 20 transmitted from the target terminal 30. In the next step S12, the position estimation device 10 estimates the positions of the target terminals 30 by using the k-hop connection probability calculated by the target position calculator 101 in step S10 and the hop counts acquired from the target terminals 30 in step S11.

Hereinafter, the processes in steps S10 to S12 will be described in more detail. First, prior to description of the processes, the definition of the k-hop connection probability will be described. The k-hop connection probability for a given distance d is represented by “P(k|d)” according to the notation of probability, and refers to a probability that the shortest path length (the smallest hop count) between any pair of terminals A and B with the distance d therebetween is k.

Various methods for calculating the k-hop connection probability P(k|d) are known, and the k-hop connection probability P(k|d) can be calculated by the following expression (1), for example. In the expression (1), a function gₖ(d) is expressed by an expression (2).

$$\begin{matrix}P ( k \vert d ) = {g}_{k } ( d ) {\prod }_{i = 1}^{k - 1} ( 1 - {g}_{i} ( d ) ) & ( 1 ) \\ {g}_{k} ( d ) = 1 - exp ( {\int }_{A} ρ {g}_{1} ( x - d ) {g}_{k - 1} ( x ) {\prod }_{i = 1}^{k - 2} ( 1 - {g}_{i} ( x ) ) d x ) & ( 2 )\end{matrix}$$

With the calculation formula of the expression (1), (k−1)−ple integral is required to calculate the k-hop connection probability P(k|d), which results in an enormous amount of calculation and a high calculation cost. Thus, in the first embodiment, a calculation method for calculating the k-hop connection probability P(k|d) with a smaller calculation amount will be provided.

FIG. 9 is an example flowchart illustrating the process at the k-hop connection probability calculator 102 in step S10 of FIG. 8 in more detail. In step S100, the k-hop connection probability calculator 102 acquires a 1-hop connection probability P(1|d) between nodes. Note that the nodes refer to the anchor terminals 20 and the target terminals 30. In the next step S101, the k-hop connection probability calculator 102 discretely calculates the k-hop connection probability P(k|d). In the next step S102, the k-hop connection probability calculator 102 expresses the k-hop connection probability P(k|d) as a function of a distance.

Hereinafter, the processes in steps S100 to S102 will be described. First, the method for calculating the 1-hop connection probability P(1|d) in step S100 will be described. Examples of the method for calculating the 1-hop connection probability P(1|d) include a method using a disk model and a method using a probability model.

The disk model is a model in which the connection probability is 1 when the distance d is within a distance over which communication is possible and the connection probability is 0 when the distance d is larger than the distance over which communication is possible. When the distance over which communication is possible is l, for example, the 1-hop connection probability P(1|d) can be calculated by the following expression (3).

$$P ( 1 \vert d ) = \{ \begin{matrix}1 & if d \leq 1 \\ 0 & if d > 1\end{matrix} \qquad ( 3 )$$

In contrast, the probability model is a model in which a cause such as fading that affects wireless communication is taken into consideration, and in which the connection probability is a value from 0 to 1 depending on the distance d. In a Rayleigh fading model, for example, the 1-hop connection probability P(1|d) is expressed by the following expression (4). In the expression (4), a value β and a value η are constants according to the environment.

P(1|d)=exp(−β·d^{η}) (4)

In step S100, it is determined which of the disc model and the probability model described above is to be used for calculating the 1-hop connection probability P(1|d), and parameters are acquired, for example. The model to be used may be set in advance by the position estimation device 10 or may be set by a user input or the like. The parameters are the distance l over which communication is possible in the disk model, or the constants β and η in the probability mode, for example. There parameters may be input to the position estimation device 10 via the input/output I/F 1005, for example, and stored in the storage unit 105 or may be stored in advance in the storage unit 105.

In the next step S101, the k-hop connection probability calculator 102 discretely calculates the k-hop connection probability P(k|d). Specifically, the k-hop connection probability calculator 102 determines a distance dⱼ for each value j (j is an integer; 0<j<m+1), and calculates the k-hop connection probability P(k|dⱼ). Note that the value m is an arbitrary positive integer, and the distance dⱼ is an arbitrary distance.

In the first embodiment, the k-hop connection probability calculator 102 calculates the k-hop connection probability P(k|dⱼ) on the basis of simulation. Herein, the Monte Carlo method that is known is used for simulation, and the k-hop connection probability calculator 102 calculates the k-hop connection probability P(k|dⱼ) by using the 1-hop connection probability P(1|d) obtained in step S100 and the Monte Carlo method according to the following procedures (A) to (C).

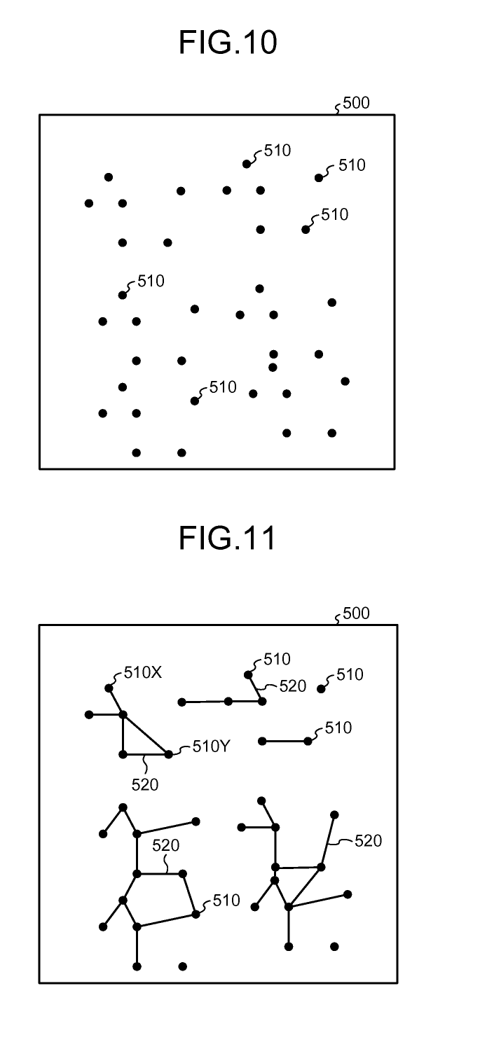

(A) The k-hop connection probability calculator 102 randomly generates coordinates of N nodes 510, 510, . . . in an area 500 as illustrated in FIG. 10. The area 500 corresponds to an area in which the anchor terminals 20 and the target terminals 30 are actually placed. When the area in which the anchor terminals 20 and the target terminals 30 are actually place is a square area of 500 m×500 m, the k-hop connection probability calculator 102 virtually generates the square area 500 of 500 m×500 m.

(B) Subsequently, the k-hop connection probability calculator 102 generates connection links for pairs of nodes among the nodes 510, 510, . . . generated in the area 500. The k-hop connection probability calculator 102 obtains the distance d between nodes for each node pair combining two nodes among the nodes 510, 510, . . . on the basis of the coordinates of the nodes 510, 510, . . . . The k-hop connection probability calculator 102 then generates the presence or the absence of a link for each node pair by using the 1-hop connection probability P(1|d) obtained in step S100 on the basis of the obtained distance d. FIG. 11 illustrates an example in which links 520 are generated for the nodes 510 in the area 500.

In a case where the 1-hop connection probability P(1|d) obtained in step S100 is the disk model expressed by the expression (3), for example, a link is generated if the 1-hop connection probability P(1|d) is 1 and no link is generated if the 1-hop connection probability P(1|d) is 0. In the case of the probability model as in the expression (4), the 1-hop connection probability P(1|d) is first calculated, a real number r(0≦r≦1) is randomly generated, a link is generated if the real number r is equal to or smaller than the 1-hop connection probability P(1|d) and no link is generated otherwise.

(C) Finally, the k-hop connection probability calculator 102 discretely calculates the k-hop connection probability P(k|dⱼ). Specifically, the k-hop connection probability calculator 102 calculates the k-hop connection probability P(k|dⱼ) for each distance dⱼ.

First, the k-hop connection probability calculator 102 calculates the hop counts (the shortest path lengths) of all the node pairs. The hop count between a node 510X and a node 510Y in FIG. 11 is 2, for example. Subsequently, the k-hop connection probability calculator 102 calculates the k-hop connection probability P(k|dⱼ) for each distance dⱼ. The k-hop connection probability calculator 102 determines a positive value Δ. Note that the value Δ is an arbitrary positive value.

The k-hop connection probability calculator 102 obtains node pairs with distances d between nodes satisfying dⱼ−Δ≦d≦dⱼ+Δ from all the node pairs in the area 500, and counts the number T of obtained node pairs. The k-hop connection probability calculator 102 further obtains the number Tₖ of pairs with hop counts being k from among the obtained node pairs. The k-hop connection probability calculator 102 calculates the k-hop connection probability P(k|dⱼ) for each distance dⱼ by using the obtained numbers T and Tₖ and assuming that P(k|dⱼ)=Tₖ/T.

In the next step S102, the k-hop connection probability calculator 102 expresses each k-hop connection probability P(k|dⱼ) calculated in step S101 as a function of the distance d. More specifically, the k-hop connection probability calculator 102 obtains a function f(d) of the distance that can approximate the k-hop connection probability P(k|dⱼ) by using the k-hop connection probability P(k|dⱼ) for a distance dⱼ (0<j<m+1) calculated in step S101.

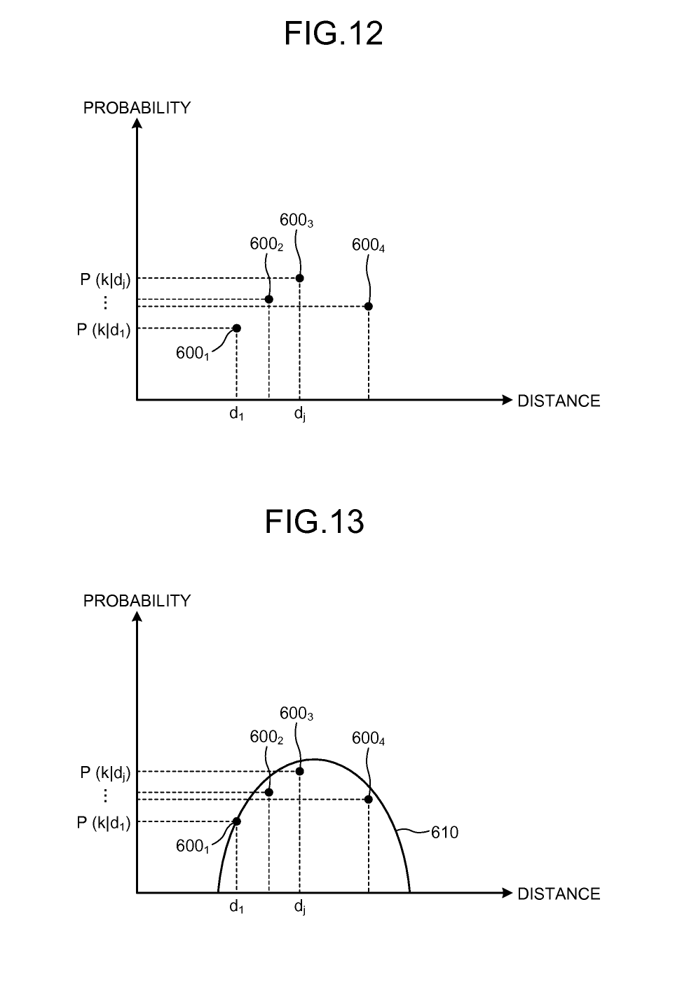

FIG. 12 illustrates an example in which the k-hop connection probability P(k|dⱼ) calculated in step S101 is plotted on coordinates in which the horizontal axis represents the dⱼ and the vertical axis represents the k-hop connection probability P(k|dⱼ). The relations between the k-hop connection probabilities P(k|d₁), . . . , P(k|dⱼ) and the distances d₁, . . . , dⱼ are indicated by points 600₁ to 600₄ on the coordinates.

FIG. 13 illustrates an example in which an appropriate fitting function f(d) is applied to the points 600₁ to 600₄ in FIG. 12. In the example of FIG. 13, the k-hop connection probability calculator 102 obtains a function f(d) of the distance d that is represented by a curve 610 that approximates the points 600₁ to 600₄ indicating the relations between the k-hop connection probabilities P(k|d₁), . . . , P(k|dⱼ) and the distances d₁, . . . , dⱼ. As a result, the k-hop connection probability P(k|dⱼ) is converted into the function f(d) of the distance.

A fitting method that can be applied to the k-hop connection probability calculator 102 will be described. First, the k-hop connection probability calculator 102 determines the type of function used for fitting. Examples of the type of function include a polynomial function, a linear function, and an exponential function.

Subsequently, the k-hop connection probability calculator 102 obtains parameters of the function to be used for fitting. Specifically, for fitting to a function f(d)=A×d²+B×d+C, for example, the k-hop connection probability calculator 102 obtains coefficients A, B, and C so that the value Error in the following expression (5) becomes the smallest. The parameters of the function f(d) can be obtained by using an fminsearch function in MATLAB (registered trademark) that is one of numerical analysis software, for example.

$$Error = {\sum }_{0 < j < m + 1} {( f ( {d}_{i} ) - P ( k \vert {d}_{j} ) )}^{2} \qquad ( 5 )$$

According to the simulation result, the exponential functions expressed by the following expressions (6) and (7) can be well fitted to the function for the distance dⱼ of the k-hop connection probability P(k|dⱼ). In the expressions (6) and (7), the parameters Aₖ, Bₖ, Cₖ, and Dₖ are values dependent on the hop count k, and are thus expressed with a subscript k.

$$\begin{matrix}f ( d ) = {e}^{{{A}_{k} ( d - {B}_{k} )}^{2} + {C}_{k}} & ( 6 ) \\ f ( d ) = {e}^{{{A}_{k} ( d - {B}_{k} )}^{{D}_{k}} + {C}_{k}} & ( 7 )\end{matrix}$$

The description refers back to the flowchart of FIG. 8, in which in step S12, the target position calculator 101 estimates the positions of the target terminals 30 by using the k-hop connection probability P(k|dⱼ) obtained in the processes in the flowchart of FIG. 9.

Hereinafter, a method for estimating the position of a target terminal 30 (referred to as a target terminal 30ₓ) by the target position calculator 101 will be described. First, the hop count between the target terminal 30ₓ and each anchor terminal 20ᵢ (0<i<M+1; M is the number of anchor terminals 20) calculated in step S11 described above is represented by a hop count hᵢ. The target position calculator 101 calculates a coordinate vector X of the target terminal 30ₓ by using the maximum likelihood method and using the following expression (8).

$$X = {arg max}_{X} P ( {d}_{1} , {d}_{2} , … , {d}_{M} \vert {h}_{1} , {h}_{2} , … , {h}_{M} ) \qquad ( 8 )$$

If it is assumed that the connection probability P(dᵢ|hᵢ) and the connection probability P(dⱼ|hⱼ) are independent of each other for any anchor terminal 20ᵢ and any anchor terminal 20ⱼ, the value of the above expression (8) is the same as that of the following expression (9).

$$X = {arg max}_{X} {\prod }_{1 \leq I \leq M}^{ } P ( {d}_{i} \vert {h}_{i} ) \qquad ( 9 )$$

In the expression (9), the value dᵢ represents the distance between the coordinate vector X and the anchor terminal 20ᵢ, and is calculated by the following expression (10).

dᵢ|X−Xᵢ| (10)

In the expression (10), the value Xᵢ is a coordinate vector of the anchor terminal 20ᵢ. Thus, in two-dimensional coordinates, the expression (10) has the same value as the following expression (11). In the expression (11), the coordinate vector X=(x, y) is coordinates of the target terminal 30ₓ to be estimated. In addition the coordinate vector Xᵢ=(xᵢ, yᵢ) is coordinates of the anchor terminal 20ᵢ.

dᵢ=\sqrt{(x−xᵢ)²+(y−yᵢ)²} (11)

In three-dimensional coordinates, the expression (10) has the same value as the following expression (12). In the expression (12), the coordinate vector X=(x, y, z) is coordinates of the target terminal 30ₓ to be estimated. In addition, the coordinate vector Xi=(xᵢ, yᵢ, zᵢ) is coordinates of the anchor terminal 20ᵢ.

dᵢ=\sqrt{(x−xᵢ)²+(y−yᵢ)²+(z−zᵢ)²} (12)

Next, calculation of the likelihood will be described. The following expression (13) is satisfied on the basis of the Bayes theorem.

$$P ( {d}_{i} \vert {h}_{i} ) = \frac{P ( {d}_{i} \vert {h}_{i} ) P ( {d}_{i} )}{P ( {h}_{i} )} \qquad ( 13 )$$

In the expression (13), since P(dᵢ) and P(hᵢ) are constants, the above expression (9) has the same value as the following expression (14).

$$X = {arg max}_{X} {\prod }_{1 \leq I \leq M}^{ } P ( {d}_{i} \vert {h}_{i} ) \qquad ( 14 )$$

The target position calculator 101 calculates the expression (14) by using the k-hop connection probability calculated in step S10 described above, that is the expression (6) or the expression (7). As an example, the target position calculator 101 can calculate the expression (14) by the following expression (15) by using the expression (7) to obtain the coordinate vector X and estimate the position of the target terminal 30ₓ.

$$\begin{matrix}X = {arg max}_{X} {\prod }_{1 \leq i \leq M}^{ } P ( {d}_{i} \vert {h}_{i} ) \\ = {arg max}_{X} {\prod }_{1 \leq i \leq M}^{ } {e}^{( {{A}_{{h}_{i}} ( {d}_{i} - {B}_{{h}_{i}} )}^{{D}_{{h}_{i}}} + {C}_{{h}_{i}} )}\end{matrix} \qquad ( 15 )$$

The expression (15) can be solved by using the steepest descent method of the Newton method, which are known, for example. Alternatively, the expression (15) into which a fitting function other than the expression (6) and the expression (7) is substituted can also be solved by using the steepest descent method or the like.

As described above, according to the first embodiment, the positions of the target terminals 30 are estimated on the basis of the connection probability taking the hop counts and the distance between the anchor terminals 20 and the target terminals 30 into consideration. Consequently, the positions of the target terminal 30 can be estimated with higher accuracy.

Furthermore, in the first embodiment, calculation is conducted by using the maximum likelihood method and the fitting function, which allows estimation of the positions of the target terminals 30 with a smaller calculation amount than the case where the above expression (1) is used.

### Second Embodiment

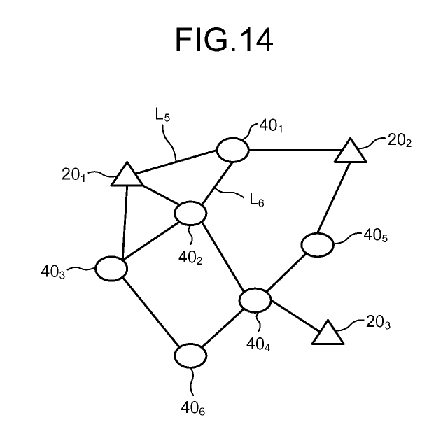

Next, a second embodiment will be described. In the second embodiment, a target terminal also functions as the position estimation device 10 of the first embodiment, and estimates its position. FIG. 14 schematically illustrates an example of a wireless mesh network that can be applied to the second embodiment. In FIG. 14, components that are the same as those in FIG. 2 described above will be designated by the same reference numerals and detailed description thereof will not be repeated.

In FIG. 14, the wireless mesh network according to the second embodiment includes three or more anchor terminals 20₁, 20₂, . . . and a plurality of target terminal 40₁, 40₂, . . . .

The anchor terminals 20₁, 20₂, . . . are reference wireless devices whose positions are known as described above. Since the configurations of the anchor terminals 20 are the same as those of the anchor terminals 20 illustrated in FIGS. 3A and 3B, detailed description thereof will not be repeated here. In the second embodiment, when the positions of the anchor terminal 20₁, 20₂, . . . are registered in the target terminals 40₁, 40₂, . . . , the position acquisition unit 200, for example, is unnecessary.

The target terminals 40₁, 40₂, . . . are terminals whose positions are unknown, and estimate their own positions. Hereinafter, the target terminal 40₁, 40₂, . . . will be represented by a target terminal 40 unless the target terminal 40₁, 40₂, . . . are particularly distinguished from one another.

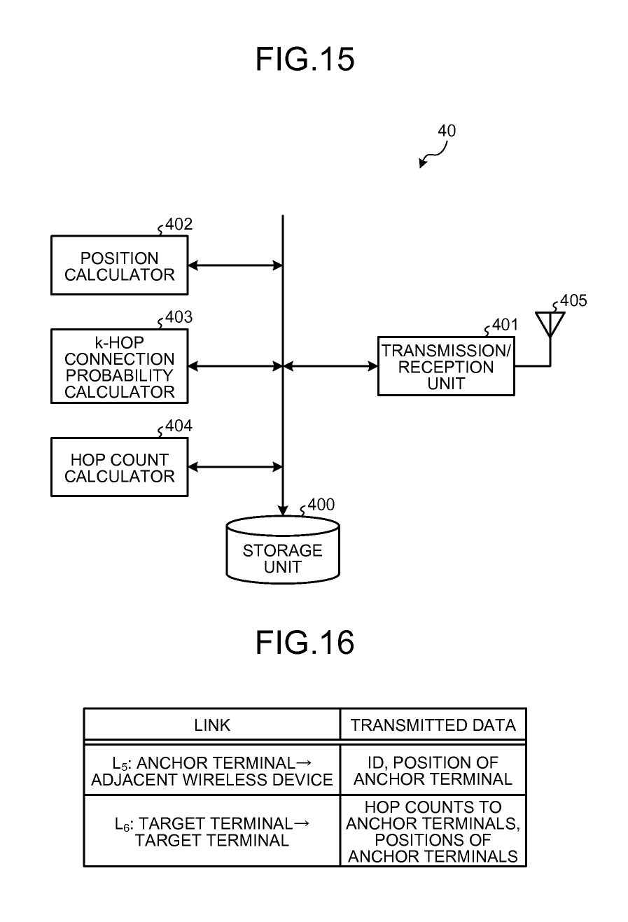

FIG. 15 illustrates an example configuration of a target terminal 40 according to the second embodiment. The target terminal 40 includes a storage unit 400, a transmission/reception unit 401, a position calculator 402, a k-hop connection probability calculator 403, a hop count calculator 404, and an antenna 405.

In the target terminal 40, the hop count calculator 404 corresponds to the hop count calculator 300 described with reference to FIG. 4, and calculates the hop counts with respect to the anchor terminals 20 by the method described in the first embodiment. The transmission/reception unit 401 transmits and receives signals via the antenna 405. More specifically, the transmission/reception unit 401 transmits the hop counts calculated by the hop count calculator 404 to an adjacent wireless device. The transmission/reception unit 401 also receives the hop counts of an adjacent target terminal 40 with respect to the anchor terminals 20 transmitted from the adjacent target terminal 40.

The transmission/reception unit 401 further receives, from an adjacent anchor terminal 20, an anchor ID and position information indicating the position of the anchor terminal 20. When the position of the anchor terminal 20 is preset and stored in the storage unit 400, for example, of the target terminal 40, the position information indication the position of the anchor terminal 20 need not be received.

The storage unit 400 stores the positions of the anchor terminals 20 and the hop counts with respect to the anchor terminals 20.

The k-hop connection probability calculator 403 calculates the k-hop connection probability P(k|dⱼ) according to the method described using the expressions (3) to (7) in step S10 in FIG. 8 and steps S100 to S102 in FIG. 9 similarly to the k-hop connection probability calculator 102 of the position estimation device 10 in the first embodiment.

In the second embodiment, note that the k-hop connection probability P(k|dⱼ) may be calculated in advance similarly to the above by using a computer or the like and the fitting function f(d) for the k-hop connection probability P(k|dⱼ) may be obtained prior to setup of the wireless mesh network according to the second embodiment. The parameters of the obtained function f(d) may be stored in advance in the storage units 400 of the target terminals 40, for example. In this case, the k-hop connection probability calculator 403 in each target terminal 40 is unnecessary.

The position calculator 402 calculates the positions of the target terminals 40 according to the method described using the expressions (8) to (15) in step S12 in FIG. 8 similarly to the target position calculator 101 of the position estimation device 10 in the first embodiment.

FIG. 16 illustrates information transmitted and received among the anchor terminals 20 and the target terminals 40 according to the second embodiment. With reference to FIG. 14, through the path L₅, that is a link from an anchor terminal 20 to an adjacent wireless device, the anchor ID of the anchor terminal 20 and position information indicating the position of the anchor terminal 20 are transmitted. Through the path L₆, that is a link from a target terminal 40 to another target terminal 40, the hop counts of the target terminal 40 with respect to the anchor terminals 20 and position information indicating the positions of the anchor terminal 20 are transmitted.

As described above, since the target terminal 40 includes the position calculator 402, the k-hop connection probability calculator 403, and the storage unit 400, the positions of the target terminals 40 can be estimated without any position estimation device 10 separately provided in the wireless mesh network.

### Third Embodiment

Next, a third embodiment will be described. In the third embodiment, the k-hop connection probability calculator 102 according to the first embodiment and the k-hop connection probability calculator 403 according to the second embodiment described above calculate the k-hop connection probability by methods different from those described above. More specifically, unlike the k-hop connection probability P(k|d) in the first and second embodiments described above, the k-hop connection probability is calculated as a connection probability P(d|k). Specifically, in the third embodiment, the k-hop connection probability is obtained from a probability that the distance between nodes is d when k is given as the smallest hop count. Hereinafter, in the third embodiment, the connection probability P(d|k) will be described as the k-hop connection probability.

Herein, it is assumed for explanation that the wireless mesh network has the configuration as illustrated in FIG. 2 and that the position estimation device 10 estimates the positions of the target terminals 30.

In the third embodiment, the k-hop connection probability P(d|k) is obtained and the positions of the target terminals 30 are estimated basically according to the flowcharts of FIGS. 8 and 9 described above. In the third embodiment, note that the discrete calculation process of calculating the k-hop connection probability P(d|k) in step S101 of the flowchart of FIG. 9 is different from that described above. Hereinafter, the discrete calculation process of calculating the k-hop connection probability P(d|k) in the third embodiment will be described.

With reference to the flowchart of FIG. 9, in step S101, the k-hop connection probability calculator 102 discretely calculates the k-hop connection probability P(d|k). Specifically, in the third embodiment, the k-hop connection probability calculator 102 determines a distance dⱼ for each value j (j is an integer: 0<j<m+1), and calculates the k-hop connection probability P(dⱼ|k). Note that the value m is an arbitrary positive integer, and the distance dⱼ is an arbitrary distance.

The calculation method is substantially the same as the procedures (A) to (C) described above and the Monte Carlo method is used therefor, but the procedure (C) is different (referred to as a procedure (C′)). Hereinafter, the calculation method according to the third embodiment will be described mainly on the difference from the procedures (A) to (C) according to the first embodiment.

(A) The k-hop connection probability calculator 102 randomly generates coordinates of N nodes 510, 510, . . . in an area 500 as illustrated in FIG. 10.

(B) Subsequently, the k-hop connection probability calculator 102 obtains the distance d between nodes for each node pair combining two nodes among nodes 510, 510, . . . generated in an area 500 on the basis of the coordinates of the nodes 510, 510, . . . . The k-hop connection probability calculator 102 then generates connection links for the pairs of nodes on the basis of one of the expressions (3) and (4) according to the model adopted from the disk model and the probability model.

(C′) Finally, the k-hop connection probability calculator 102 discretely calculates the k-hop connection probability P(dⱼ|k). In this case, the k-hop connection probability calculator 102 calculates the hop counts (the smallest path lengths) of all the node pairs. Subsequently, the k-hop connection probability calculator 102 calculates the k-hop connection probability P(dⱼ|k) for each distance dⱼ. The k-hop connection probability calculator 102 determines a value Δ that is an arbitrary positive value.

The k-hop connection probability calculator 102 obtains the number Tₖ of node pairs with distances d between nodes satisfying dⱼ−Δ≦d≦dⱼ+Δ and the hop counts being k from all the node pairs in the area 500. The k-hop connection probability calculator 102 also obtains the number T of all the node pairs with the hop counts being k. The k-hop connection probability calculator 102 then calculates the k-hop connection probability P(dⱼ|k) for each distance dⱼ by using the obtained numbers T and Tₖ and assuming that P(dⱼ|k)=Tₖ/T.

The k-hop connection probability P(dⱼ|k) in the third embodiment can be expressed as a function f(d) of the distance d similarly to the method described in step S102 in FIG. 9 in the first embodiment. Thus, in the third embodiment as well, the positions of the target terminals 30 can be estimated similarly to the method described in step S12 in FIG. 8 in the first embodiment.

Specifically, the k-hop connection probability P(dⱼ|k) obtained in the third embodiment is substituted into the expression (9) similarly to step S12 in FIG. 8 in the first embodiment. Subsequently, the positions of the target terminals 30 are obtained by calculating the coordinate vector X according to the expressions (10) to (15) described above.

### Fourth Embodiment

Next, a fourth embodiment will be described. In the fourth embodiment, the k-hop connection probability calculator 102 according to the first embodiment and the k-hop connection probability calculator 403 according to the second embodiment described above calculate the k-hop connection probability by methods different from those described above. More specifically, unlike the k-hop connection probability P(k|d) in the first and second embodiments, the k-hop connection probability is calculated as a probability P(k|d)×P(d). Hereinafter, in the fourth embodiment, the probability P(k|d)×P(d) is described as the k-hop connection probability.

Herein, it is assumed for explanation that the wireless mesh network has the configuration as illustrated in FIG. 2 and that the position estimation device 10 estimates the positions of the target terminals 30.

In the fourth embodiment, the k-hop connection probability P(k|d)×P(d) is obtained and the positions of the target terminals 30 are estimated basically according to the flowcharts of FIGS. 8 and 9 described above. In the fourth embodiment, note that the discrete calculation process of calculating the k-hop connection probability P(k|d)×P(d) in step S101 of the flowchart of FIG. 9 is different from that described above. Hereinafter, the discrete calculation process of calculating the k-hop connection probability P(k|d)×P(d) in the fourth embodiment will be described.

With reference to the flowchart of FIG. 9, in step S101, the k-hop connection probability calculator 102 discretely calculates the k-hop connection probability P(k|d)×P(d). Specifically, in the fourth embodiment, the k-hop connection probability calculator 102 determines a distance dⱼ for each value j (j is an integer: 0<j<m+1), and calculates the k-hop connection probability P(k|dⱼ)×P(dⱼ). Note that the value m is an arbitrary positive integer, and the distance dⱼ is an arbitrary distance.

The calculation method is substantially the same as the procedures (A) to (C) described above and the Monte Carlo method is used therefor, but the procedure (C) is different (referred to as a procedure (C″)). Hereinafter, the calculation method according to the third embodiment will be described mainly on the difference from the procedures (A) to (C) according to the first embodiment.

(A) The k-hop connection probability calculator 102 randomly generates coordinates of N nodes 510, 510, . . . in an area 500 as illustrated in FIG. 10.

(B) Subsequently, the k-hop connection probability calculator 102 obtains the distance d between nodes for each node pair combining two nodes among nodes 510, 510, . . . generated in an area 500 on the basis of the coordinates of the nodes 510, 510, . . . . The k-hop connection probability calculator 102 then generates connection links for the pairs of nodes on the basis of one of the expressions (3) and (4) according to the model adopted from the disk model and the probability model.

(C″) Finally, the k-hop connection probability calculator 102 discretely calculates the k-hop connection probability P(k|dⱼ)×P(dⱼ). In this case, the k-hop connection probability calculator 102 calculates the hop counts (the smallest path lengths) of all the node pairs. Subsequently, the k-hop connection probability calculator 102 calculates the k-hop connection probability P(k|d)×P(d) for each distance dⱼ. The k-hop connection probability calculator 102 determines a value Δ that is an arbitrary positive value.

The k-hop connection probability calculator 102 obtains the number Tₖ of node pairs with distances d between nodes satisfying dⱼ−Δ≦d≦dⱼ+Δ and the hop counts being k from all the node pairs in the area 500. The k-hop connection probability calculator 102 also obtains the number T of all the node pairs with the hop counts being k. The k-hop connection probability calculator 102 further obtained the number T_{d} of node pairs with the node distances between nodes satisfying dⱼ−Δ≦d≦dⱼ+Δ. Furthermore, the k-hop connection probability calculator 102 obtains the number Tₚ of all the node pairs. Note that, when a value N represents the number of all the nodes in the area 500, the number Tₚ can be obtained as Tₚ=N×(N−1)/2.

The k-hop connection probability calculator 102 then calculates the k-hop connection probability P(k|dⱼ)×P(dⱼ) for each distance dⱼ by using the obtained numbers T, Tₖ, T_{d}, and Tₚ and assuming that P(k|dⱼ)×P(dⱼ)=(Tₖ×Tⱼ)/(T×Tₚ).

The k-hop connection probability P(k|dⱼ)×P(dⱼ) in the fourth embodiment can be expressed as a function f(d) of the distance d similarly to the method described in step S102 in FIG. 9 in the first embodiment. Thus, according to the fourth embodiment as well, the positions of the target terminals 30 can be estimated similarly to the method described in step S12 in FIG. 8 in the first embodiment.

Specifically, the coordinate vector X of the target terminal 30 is obtained by using the expression (9) similarly to step S12 in FIG. 8 in the first embodiment. The expression (9) has the same value as an expression (16) as described using the expression (13) in the first embodiment. The target position calculator 101 can thus calculate the coordinate vector X of the target terminal 30 by substituting the k-hop connection probability P(k|dⱼ)×P(dⱼ) into the expression (16), and obtain the position of the target terminal 30.

$$\begin{matrix}X = {arg max}_{X} {\prod }_{1 \leq i \leq M}^{ } P ( {d}_{i} \vert {h}_{i} ) \\ = {arg max}_{X} {\prod }_{1 \leq i \leq M}^{ } \frac{P ( {h}_{i} \vert {d}_{i} ) P ( {d}_{i} )}{P ( {h}_{i} )} \\ = {arg max}_{X} {\prod }_{1 \leq i \leq M}^{ } P ( {h}_{i} \vert {d}_{i} ) P ( {d}_{i} )\end{matrix} \qquad ( 16 )$$

### Fifth Embodiment

Next, a fifth embodiment will be described. In the fifth embodiment, the target position calculator 101 in the first embodiment and the position calculator 402 in the second embodiment described above apply weighting to the estimation of the positions of the target terminals 30 or the target terminals 40. Herein, it is assumed for explanation that the wireless mesh network has the configuration as illustrated in FIG. 2 and that the position estimation device 10 estimates the positions of the target terminals 30.

First, with reference to FIG. 8, the hop count between the target terminal 30ₓ and each anchor terminal 20ᵢ (0<i<M+1; M is the number of anchor terminals 20 in the area 500) calculated in step S11 described above is represented by a hop count hᵢ. The target position calculator 101 calculates a coordinate vector X of the target terminal 30ₓ by using the maximum likelihood method and using the expression (8) described above.

Note that it is assumed in the first embodiment that the connection probability P(dᵢ|hᵢ) and the connection probability P(dⱼ|hⱼ) are independent of each other for any anchor terminal 20ᵢ and any anchor terminal 20ⱼ. In actual disposition, however, there may be cases where the connection probability P(dᵢ|hᵢ) and the connection probability (dⱼ|hⱼ) are not independent of each other. In a case where the distance between the anchor terminal 20ᵢ and the anchor terminal 20ⱼ is small of a case where the hop count between the anchor terminal 20ᵢ and the anchor terminal 20ⱼ is small, for example, the dependency of the connection probability P(dᵢ|hᵢ) and the connection probability P(dⱼ|hⱼ) on each other is higher.

It is difficult to accurately calculate the dependency of the connection probability P(dᵢ|hᵢ) and the connection probability P(dⱼ|hⱼ) on each other. Thus, in the fifth embodiment, a function wᵢ including at least one of the distance and the hot count between the anchor terminal 20ᵢ and another anchor terminal 20 as a parameter is used as a weight to calculate the coordinate vector X of the target terminal 30.

As a specific example, the target position calculator 101 applies the aforementioned function wᵢ to the probability P(dᵢ|hᵢ) in the aforementioned expression (9) as expressed by the following expression (17).

$$X = {arg max}_{X} {\prod }_{1 \leq i \leq M}^{ } {P ( {d}_{i} \vert {h}_{i} )}^{{w}_{i}} \qquad ( 17 )$$

Subsequently, the target position calculator 101 obtains the positions of the target terminals 30 by calculating the coordinate vector X according to the expressions (10) to (15) described above.

As described above, in the fifth embodiment, for obtaining the positions of the target terminals 30, the function wᵢ including at least one of the distance and the hot count between the anchor terminal 20ᵢ and another anchor terminal 20 as a parameter is used as a weight. Consequently, the positions of the target terminals 30 can be obtained with higher accuracy even when the distance between the anchor terminal 20ᵢ and the anchor terminal 20ⱼ is short or when the hot count between the anchor terminal 20ᵢ and the anchor terminal 20ⱼ is small.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A position estimation device for estimating a position of a second terminal in a wireless network including a plurality of terminals including three or more first terminals whose positions are known and the second terminal whose position is unknown, the device comprising:
a first probability calculator configured to calculate a first connection probability on the basis of a distance and a hop count between two of the plurality of terminals over which and with which the two terminals are connected; and
a position estimator configured to estimate a position of the second terminal on the basis of the first connection probability.

2. The device according to claim 1, wherein the first probability calculator includes:
a second probability calculator configured to
calculate a second connection probability that two terminals included in the plurality of terminals can directly connect with each other, and
create links between the terminals on the basis of the second connection probability; and
a third probability calculator configured to
calculate the first connection probability for each distance between two terminals between which the link is created, and
convert the first connection probability into a function of the distance.

3. The device according to claim 2, wherein the third probability calculator converts the first connection probability into an exponential function of the distance.

4. The device according to claim 1, wherein
the position estimator estimates the position by using, as the first connection probability, at least one of:
a first probability that two terminals to which a distance therebetween is given connect with each other with a smallest hop count,
a second probability that a distance between two terminals to which the smallest hop count is given is a given distance, and
a third probability that is a product of a probability that a distance between two terminals is a given distance and the second probability.

5. The device according to claim 1, wherein the position estimator applies weighting to the first connection probability to estimate the position.

6. The device according to claim 1, wherein
the first probability calculator calculates the first connection probability on the basis of the distance and a smallest hop count between the two terminals.
